(19) United States
(12) Patent Application Publication
(10) Pub. No.: US 2017/0169028 A1
(43) Pub. Date: Jun. 15, 2017

(54) DYNAMIC CUSTOMIZED CONTENT BASED ON USER BEHAVIOR

(71) Applicant: LinkedIn Corporation, Mountain View, CA (US)

(72) Inventor: Jonathan L. Sherman-Presser, San Francisco, CA (US)

(73) Assignee: LinkedIn Corporation, Mountain View, CA (US)

(21) Appl. No.: 14/970,383

(22) Filed: Dec. 15, 2015

(51) Int. Cl. G06F 17/30

(52) U.S. Cl. CPC G06F 17/3053; G06F 17/30569; G06F 17/30011; G06F 17/30867; G06F 17/3089; G06F 17/30029

(57) ABSTRACT

In order to dynamically generate customized content, a set of format options for a document (including layout and/or ordering) may be defined and user behaviors in a social network associated with different versions of the document may be tracked. For example, the user behaviors may include a number of views of the document, a percentage of the document viewed and/or a viewing time of the document. This customization technique allows feedback based on user behaviors to guide revisions to the format of the document, such as selecting different format options for particular subgroups of the users (which may even be individually specific). The resulting customized content can be presented concurrently, so that different users can view different versions of the same document at the same time.

### BACKGROUND

Field

The described embodiments relate to techniques for dynamically customizing content. More specifically, the described embodiments relate to techniques for dynamically customizing content based on user behavior.

Related Art

The popularity of electronic devices and networked communication has resulted in a significant increase in electronic interactions among individuals. For example, individuals regularly exchange presentations, video and, more generally, content with each other using these systems.

While these capabilities have significantly increased the amount of available content, much of the content is poorly suited to the needs of any given individual. For example, the content rarely reflects the preferences of a given individual. Consequently, much of the available content is ignored or rarely used.

Furthermore, attempts at addressing this problem by adapting content based on fixed or static rules often fail because the static rules are unable to handle the significant variations in the content. Consequently, existing approaches for presenting content may be inadequate, which is frustrating to many individuals.

### BRIEF DESCRIPTION OF THE FIGURES

FIG. 1 is a block diagram illustrating a system used to generate content in accordance with an embodiment of the present disclosure.

FIG. 2 is a flow chart illustrating a method for generating customized content in accordance with an embodiment of the present disclosure.

FIG. 3 illustrates communication between the electronic devices of FIG. 1 in accordance with an embodiment of the present disclosure.

FIG. 4 is a drawing illustrating a version of a set of documents in accordance with an embodiment of the present disclosure.

FIG. 5 is a drawing illustrating another version of the set of documents in FIG. 4 in accordance with an embodiment of the present disclosure.

FIG. 6 is a drawing illustrating a social graph in accordance with an embodiment of the present disclosure.

FIG. 7 is a block diagram illustrating a computer system that performs the methods of FIGS. 2 and 3 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to dynamically generate customized content, a set of format options for a document (including layout and/or ordering) may be defined and user behaviors in a social network associated with different versions of the document may be tracked. For example, the user behaviors may include a number of views of the document, a percentage of the document viewed and/or a viewing time of the document. This customization technique allows feedback based on user behaviors to guide revisions to the format of the document, such as selecting different format options for particular subgroups of the users (which may even be individually specific). The resulting customized content can be presented concurrently, so that different users can view different versions of the same document at the same time.

In this way, the customization technique may be used to dynamically generate customized content for small groups of users or even individuals. This customized content may increase relevance and, thus, usage of the content, as well as user engagement with the social network. Consequently, the customization technique may increase membership in the social network, and therefore may increase the revenue and/or profitability of a provider of the social network.

In the discussion that follows, a user may be a person (for example, an existing user of the social network or a new user of the social network, who are sometimes referred to as ‘members’). Also, or instead, the customization technique may be used by any type of organization, such as a business. Furthermore, a ‘business’ should be understood to include for-profit corporations, non-profit corporations, groups (or cohorts) of individuals, sole proprietorships, government agencies, partnerships, etc.

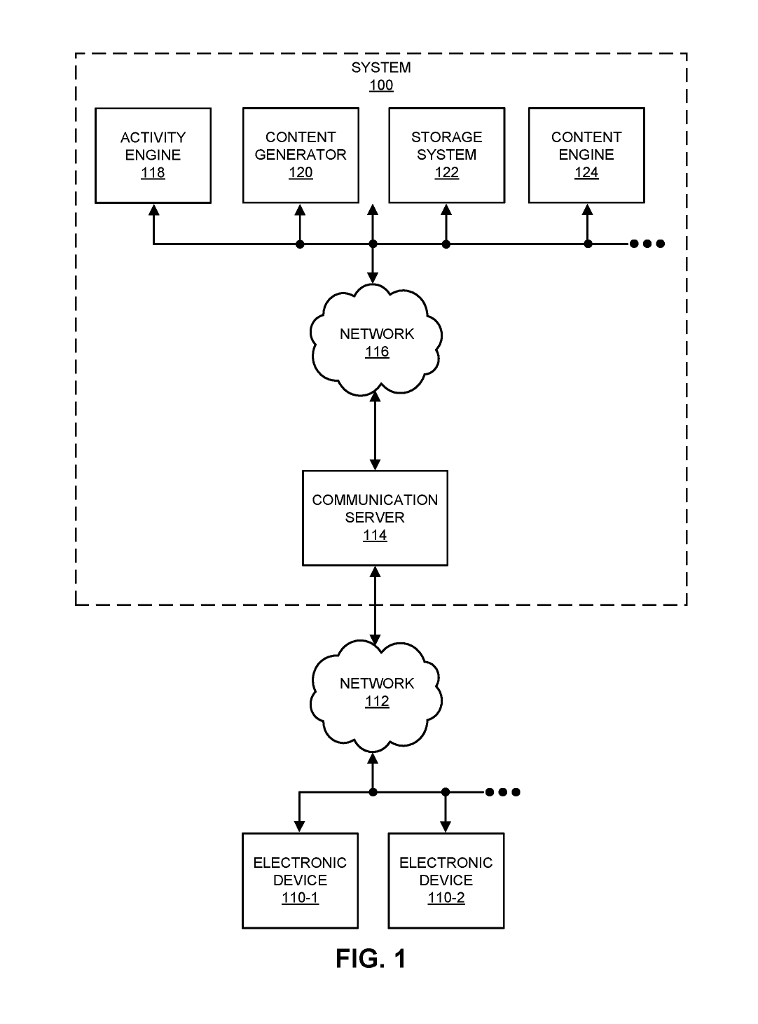

We now describe embodiments of the system and its use. FIG. 1 presents a block diagram illustrating a system 100 that performs the customization technique. In this system, users of electronic devices 110 may use a software product, such as instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

Using one of electronic devices 110 (such as electronic device 110-1) as an illustrative example, a user of electronic device 110-1 may use the software application to interact with other users in a social network (and, more generally, a network of users), such as a professional social network, which facilitates interactions among the users. The interactions among the users may specify a social graph in which nodes correspond to the users and edges between the nodes correspond to the users' interactions, interrelationships, and/or connections.

Note that each of the users of the software application may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

In particular, when using the software application, the users may view content that was posted by other users of the social network and that may include images and/or videos. In general, however, the content may include a wide variety of content and content types, including: documents (such as word-processor documents or files), presentations, spreadsheets, web pages, websites, albums with multiple pictures, etc. In general, the content may include: audio, video, text, graphics, multimedia content, verbal, written, and/or recorded information (such as comments or commentary). Note that content may be presented to the users by content engine 124 via the software application that executes in the environment of electronic devices 110.

Over time, via network 116, an activity engine 118 in system 100 may aggregate viewing behavior of the users when they view the content. This aggregated information may be stored in a data structure, which is stored in a computer-readable memory, such as storage system 122 that may encompass multiple devices, i.e., a large-scale storage system. For example, the viewing behavior for a particular video may include an average number of images in a document that are viewed by the users and/or a number of views of a video by the users.

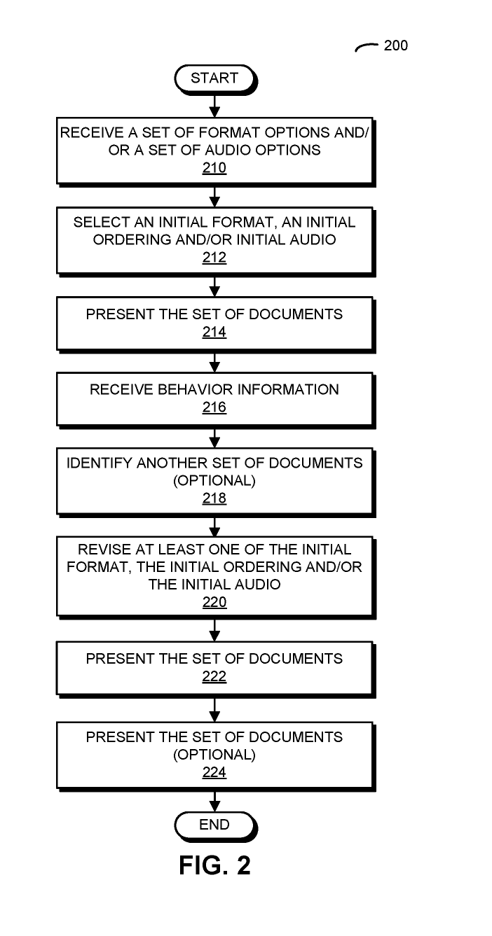

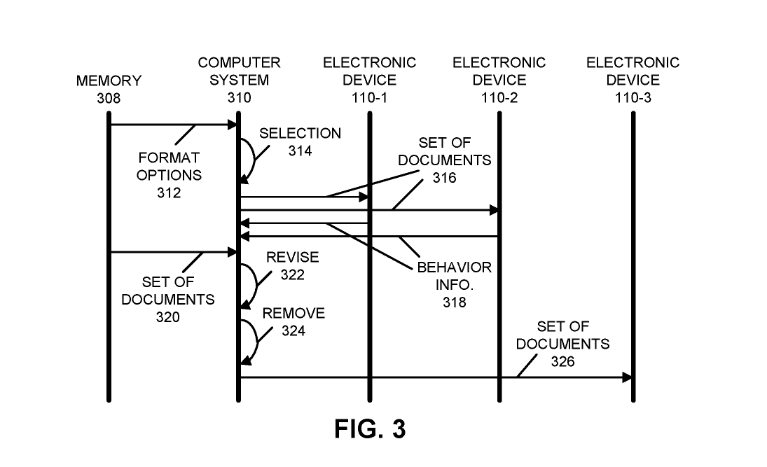

As described further below with reference to FIGS. 2 and 3, based on the user behaviors, content can be dynamically generated. In some embodiments, this content is dynamically generated on an individual-specific basis.

In particular, content generator 120 may automatically identify a set of format options for documents in a set of documents (possibly based on the available format options in an application program used to generate the set of documents) and/or audio options for documents in a set of documents (such as different music files, volume, etc.). Alternatively or additionally, the set of format options and/or the audio options may be defined or specified (e.g., by an author of the set of documents). For example, the documents may include: a page in a word-processor document, a slide in a presentation, a tab in a spreadsheet, a web page in a website, a frame in a video, etc. Moreover, the set of format options may include: fonts, font sizes, colors, locations of content in the document (such as the right-upper corner, the lower half, the upper half, and so on), etc.

Then, content generator 120 may select an initial format and an initial ordering of the documents in the set of documents, and/or initial audio for the documents in the set of documents. Alternatively or additionally, the initial format, the initial ordering of the documents and/or the initial audio may be defined or specified (e.g., by the author of the set of documents).

Next, content engine 124 may present the set of documents to a subset of users of a social network (such as one or more of the users) and, as described previously, may monitor or track user behavior in the social network. Such behavior may illustratively include: a number of views of the set of documents, a number of documents viewed in the set of documents, and/or a duration of the views. For example, content generator 120 may determine (and/or may receive from the author or retrieve from storage system 122) tags or metadata associated with the documents in the set of documents, where a tag for a given document includes characteristics of content in the given document. Note that the characteristics may include: attributes, features, qualities, properties, traits, aspects, elements, facets, classifications, associated topics, etc. Then, content generator 120 may identify the subset of the users based on the tags and profiles of the subset of the users in the social network (where each user's profile includes attributes, skills, employment history, and/or education of the user), so that a relevant subset of the users can be used to provide feedback that is used to dynamically adapt or modify the set of documents.

Note that identifying the subset of users may involve determining match scores based on association between the characteristics and the profiles, and selecting the subset of the users based on the match scores. For example, a match score for a user may be a weighted summation of matches between the characteristics and features in the user's profiles (with different features, such as education or work experience, having different weights), and the subset of the users may be those whose match scores exceed a threshold value. Alternatively or additionally, the subset of the users may be identified using a predetermined supervised-learning model that relates the characteristics and the profiles. In some embodiments, the supervised-learning model includes one of: a neural network, a classification and regression tree, a support vector machine, a regression model, etc. More generally, the subset of the users may be identified based on a statistical association (which is sometimes referred to as an ‘association’) between the characteristics and the information in the profiles.

In some embodiments, instead of or in addition to presenting the set of documents to the subset of the users, content generator 120 identifies another set of documents based on association between the tags associated with the set of documents and tags associated with the other set of documents. In these embodiments, the user behavior includes a number of views of the other set of documents, a number of documents viewed in the other set of documents, and/or a duration of the views of the other set of documents. Thus, user behavior associated with related or similar sets of documents can be used by content generator 120.

After receiving behavior information specifying user behaviors in the social network, content engine 124 may revise or modify at least one of the initial format, the initial ordering, and/or the initial audio based on the behavior information. In some embodiments, content generator 120 revises the set of documents by removing one or more of the documents in the set of documents based on the behavior information.

Moreover, content engine 124 may subsequently present the set of documents, with at least one of the revised format and the revised ordering, to other users in the social network (such as on one or more of electronic devices 110).

Thus, over time, system 100 can modify or adapt the set of documents based on user behavior that reflects user preferences or needs, in terms of what the users find interesting, what they want to view, and how they want content presented to them. Indeed, system 100 may eventually obtain numerous versions of the set of documents for presentation to different groups of users or, even, to individual users. Consequently, at any given time, system 100 may simultaneously present the set of documents to different users with different formats and/or orderings. For example, system 100 may simultaneously present the set of documents to a first user with the initial format and the initial ordering, and to a second user with the revised format and the revised ordering.

In these ways, the customization technique may allow high-quality content that is of interest to small groups of users or even individual users of the social network to be dynamically generated. This customized content may increase relevance and, thus, usage of the content, as well as user engagement with the social network. Consequently, the customization technique may increase user satisfaction with the social network, and may increase user retention and new user acquisition. Therefore, the customization technique may increase the membership of the social network, and may increase the revenue and/or the profitability of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

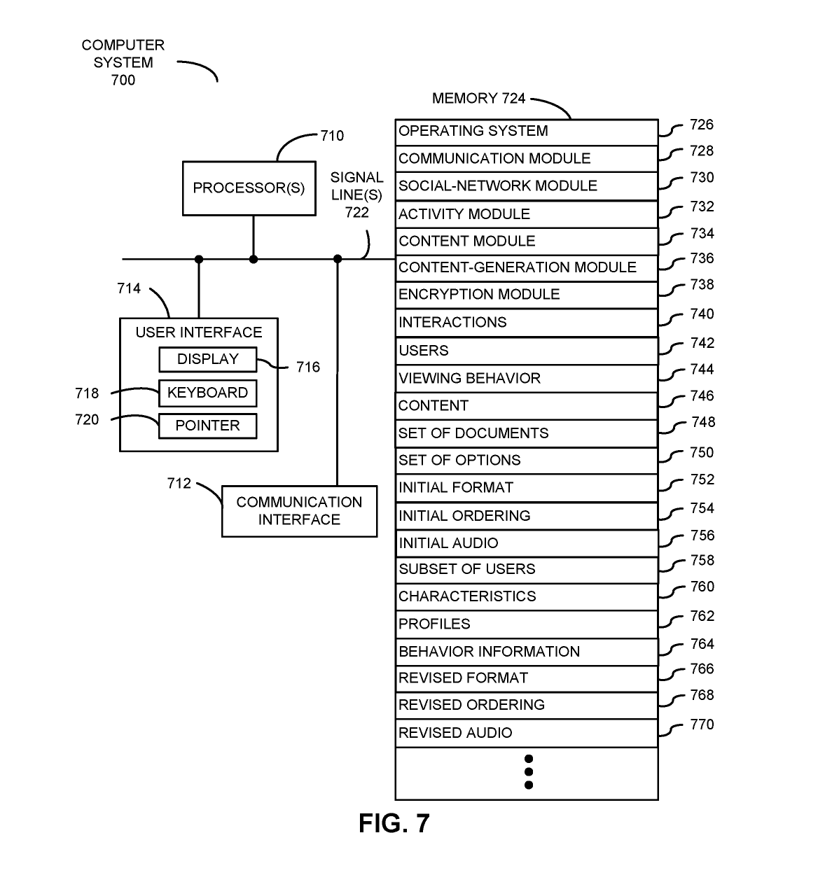

We now describe embodiments of the customization technique. FIG. 2 presents a flow chart illustrating a method 200 for generating customized content, which may be performed by a computer system (such as system 100 in FIG. 1 or computer system 700 in FIG. 7). During operation, the computer system identifies (or receives) a set of format options and/or a set of audio options (operation 210) for documents in a set of documents. For example, the set of documents may include slides in a presentation, frames in a video, etc. Then, the computer system selects (operation 212) an initial format of the documents in the set of documents, an initial ordering of the documents in the set of documents, and/or initial audio for the documents in the set of documents.

Moreover, the computer system presents the set of documents (operation 214) to a subset of users of a social network. In particular, the computer system may: determine tags associated with documents in the set of documents, where a tag for a given document includes characteristics of content in the given document; and identify the subset of the users based on the tags and profiles of the subset of the users in the social network, wherein each user's profile includes attributes, skills, employment history, and/or education of the user. In some embodiments, identifying the subset of users involves determining match scores based on association between the characteristics and the profiles, and selecting the subset of the users based on the match scores (such as users having match scores that exceed a threshold value).

Next, the computer system receives behavior information (operation 216) specifying user behaviors in the social network, where the user behaviors include a number of views of the set of documents, a number of documents viewed in the set of documents, and/or a duration of the views. Yet other behaviors may be examined in other embodiments.

Alternatively or additionally, the computer system may optionally identify another set of documents (operation 218) based on association between the tags associated with the set of documents and tags associated with the other set of documents, where the user behavior includes a number of views of the other set of documents, a number of documents viewed in the other set of documents, and/or a duration of the views of the other set of documents.

Based on the behavior information, the computer system revises at least one of the initial format, the initial ordering, and the initial audio (operation 220). In some embodiments, this revision process may include removal of one or more of the documents in the set of documents, based on the behavior information.

Finally, the computer system presents (operation 222) a version of the set of documents (with at least one of the revised format, the revised ordering, and the revised audio) to at least one user of the social network, and/or may optionally present (operation 224) another version of the set of documents (with the initial format, initial ordering, and/or initial audio) to at least another user of the social network. For example, the computer system may simultaneously present the set of documents to a first user with the initial format, the initial ordering, and/or the initial audio, and to a second user with the revised format, the revised ordering, and/or the revised audio.

In an exemplary embodiment, method 200 is implemented using one or more electronic devices and at least one server (and, more generally, a computer system), which communicate through a network, such as a cellular-telephone network and/or the Internet (e.g., using a client-server architecture). This is illustrated in FIG. 3. During this method, computer system 310 (which may implement some or all of the functionality of system 100 in FIG. 1) may identify (or receive) a set of options 312 (e.g., from memory 308), such as a set of format options and/or a set of audio options for documents in a set of documents 316. Then, computer system 310 may select 314 an initial format of the documents in set of documents 316, an initial ordering of the documents in set of documents 316 and/or initial audio for the documents in set of documents 316.

Moreover, computer system 310 may present set of documents 316 to a subset of users of a social network, such as users of electronic devices 110-1 and 110-2. As noted previously, this may involve computer system 310 identifying the subset of the users based on tags with characteristics of set of documents 316 and profiles of the users that are stored in memory 308.

Next, computer system 310 may monitor behavior information 318 specifying user behaviors in the social network, where the user behaviors include a number of views of the set of documents, a number of documents viewed in the set of documents, and/or a duration of the views. Alternatively or additionally, computer system 310 may optionally identify another set of documents 320 based on association between the tags associated with the set of documents and associated with the other set of documents, where the user behavior includes a number of views of the other set of documents, a number of documents viewed in the other set of documents, and/or a duration of the views of the other set of documents. Thus, instead of or in addition to monitoring behavior information 318, computer system 310 may use user behavior associated with a similar or a related other set of documents, which may be stored in memory 308.

Using behavior information 318, computer system 310 may revise 322 at least one of the initial format, the initial ordering, and the initial audio. In some embodiments, computer system 310 optionally removes 324 one or more of the documents in the set of documents based on behavior information 318.

Furthermore, computer system 310 may optionally present revised set of documents 326 with at least one of the revised format, the revised ordering, and the revised audio to other users in the social network, such as a user associated with electronic device 110-3.

In some embodiments of method 200, there may be additional or fewer operations. Moreover, the order of the operations may be changed, and/or two or more operations may be combined into a single operation.

In an exemplary embodiment, the customization technique is used to improve the quality of engagement of users with a social network by dynamically generating customized content. The computer system may analyze the content to determine characteristics of the content. For example, the computer system may analyze images, video, sound and/or text in the content. Then, the computer system may identify a relevant subset of the users of the social network, e.g., based on statistical associations between the characteristics and profiles of the users. For example, based on their skills, their value (such as based on their endorsements), work history, education, influential position in a community (such as the social network), a subset of the users may be identified. Next, the computer system may present the content to the identified subset of the users with an initial format, an initial ordering and/or initial audio.

Moreover, the computer system may track a variety of performance metrics and user behaviors when viewing the content (such as presentations, videos and, more generally, sets of documents). For example, the performance metrics and user behaviors may include the most-popular videos, the average-time watched, the percentage or duration watched, etc.

Based on the tracked performance metrics and the user behaviors, the computer system may iteratively revise the content to dynamically generate content that is tailored to or specific for one or more of the users of the social network. For example, based on the user behavior, the computer system may edit a set of documents, such as by changing a format, changing audio, removing documents and/or changing the order of the documents in a set of documents.

Note that the users of the social network may view the sets of documents because such customized and interesting content may be unavailable elsewhere. Moreover, this customization technique may result in professional content that can be viewed independently by individual users.

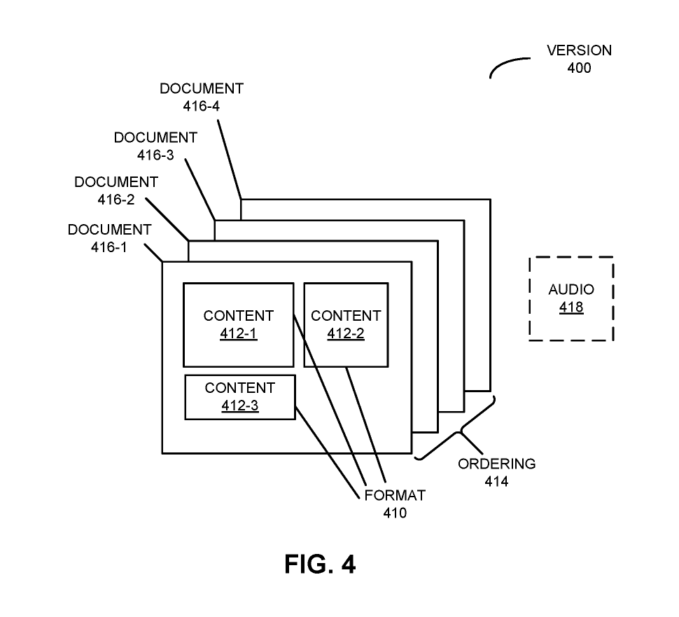

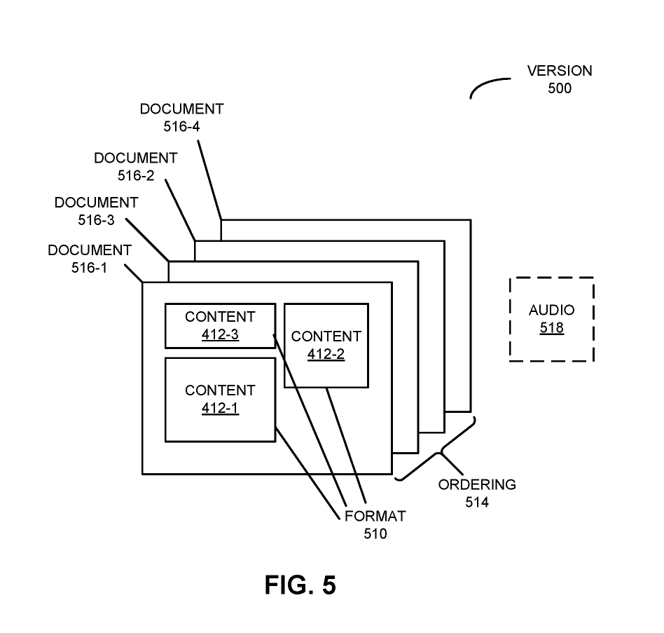

The dynamic generation of content is shown in FIGS. 4 and 5, which present drawings illustrating versions of a set of documents. In particular, FIG. 4 presents version 400 of the set of documents, which has a format 410 of content 412, an ordering 414 of documents 416, and associated audio 418. Based on user behavior (such as the viewing behavior of one or more users), similar users may see a different version of the set of documents. FIG. 5 presents version 500 of the set of documents, which has a format 510 of content 412, an ordering 514 of documents 516, and associated audio 518.

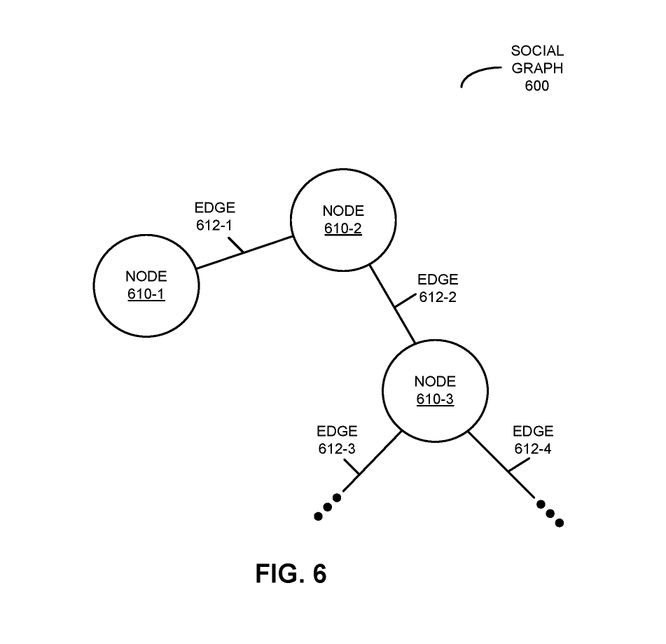

We now further describe the profiles of the users or members of the social network. The profile of a user may, at least in part, specify a social graph or a portion of a social graph. FIG. 6 presents a drawing illustrating a social graph 600. This social graph may represent the connections or interrelationships among nodes 610 (corresponding to entities) using edges 612. In the context of the customization technique, one of nodes 610 (such as node 610-1) may correspond to the user, and the remainder of nodes 610 may correspond to other users (or groups of users) in the social network. Therefore, edges 612 may represent interrelationships among these users, such as companies where they worked, schools they attended, organizations (companies, schools, etc.) that the individuals are (or used to be) associated with, interests of the users (such as particular topics or types of content), etc.

In general, a given node in social graph 600 may be associated with a wide variety of information that is included in user profiles, including attributes such as age, gender, geographic location, work industry for a current employer, functional area (e.g., engineering, sales, consulting), seniority in an organization, employer size, schools attended, previous employers, current employer, professional development, interest segments, target groups, additional professional attributes and/or inferred attributes (which may include or be based on user behaviors). Furthermore, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, and/or interest segments for the likes or shares (such as topics that are of interest to the users and/or characteristics of content that is of interest to the users). As noted previously, one or more of these features may be used in a supervised-learning model to facilitate selection of the subset of the users during the customization technique.

We now describe embodiments of a computer system for performing the customization technique and its use. FIG. 7 presents a block diagram illustrating a computer system 700 that performs methods 200 (FIGS. 2 and 3) and/or 400 (FIGS. 4 and 5), such as system 100 in FIG. 1 or computer system 310 in FIG. 3. Computer system 700 includes one or more processing units or processors 710 (which are sometimes referred to as ‘processing modules’), a communication interface 712, a user interface 714, memory 724, and one or more signal lines 722 coupling these components together. Note that the one or more processors 710 may support parallel processing and/or multi-threaded operation, the communication interface 712 may have a persistent communication connection, and the one or more signal lines 722 may constitute a communication bus. Moreover, the user interface 714 may include a display 716 (such as a touchscreen), a keyboard 718, and/or a pointer 720 (such as a mouse).

Memory 724 in computer system 700 may include volatile memory and/or non-volatile memory. More specifically, memory 724 may include: ROM, RAM, EPROM, EEPROM, flash memory, one or more smart cards, one or more magnetic disc storage devices, and/or one or more optical storage devices. Memory 724 may store an operating system 726 that includes procedures (or a set of instructions) for handling various basic system services for performing hardware-dependent tasks. Memory 724 may also store procedures (or a set of instructions) in a communication module 728. These communication procedures may be used for communicating with one or more computers and/or servers, including computers and/or servers that are remotely located with respect to computer system 700.

Memory 724 may also include multiple program modules, including social-network module 730, activity module 732, content module 734, content-generation module 736, and/or encryption module 738. Note that one or more of these program modules (or sets of instructions) may constitute a computer-program mechanism, i.e., software.

During operation of computer system 700, social-network module 730 facilitates interactions 740 among users 742 via communication module 728 and communication interface 712. These interactions may be tracked by activity module 732, and may include viewing behavior 744 of users 742 when viewing content 746, provided by content module 734, in a social network that is implemented using social-network module 730.

Then, content-generation module 736 (which is sometimes referred to as a ‘selection module’) may identify (or receive) a set of options 750, such as a set of format options and/or a set of audio options for documents in a set of documents 748. Then, content-generation module 736 may select an initial format 752 of the documents in the set of documents 748, an initial ordering 754 of the documents in the set of documents 748 and/or initial audio 756 for the documents in the set of documents 748.

Moreover, content module 734 may present the set of documents 748 to a subset of users 758 of a social network via communication module 728 and communication interface 712. As noted previously, this may involve content module 734 identifying the subset of the users 758 based on tags with characteristics 760 of the set of documents 748 and profiles 762 of users 742.

Next, as noted previously, activity module 732 may monitor behavior information 764 specifying user behaviors in the social network, where the user behaviors include a number of views of the set of documents 748, a number of documents viewed in the set of documents 748, and/or a duration of the views.

Using behavior information 764, content-generation module 736 may revise at least one of initial format 752, initial ordering 754 and/or initial audio 756, which results in revised format 766, revised ordering 768 and/or revised audio 770. In some embodiments, computer system 700 optionally removes one or more of the documents in the set of documents 748 based on behavior information 764.

Furthermore, content module 734 (which is sometimes referred to as a ‘presentation module’) may optionally present revised set of documents 748 with at least one of revised format 766, revised ordering 768, and/or revised audio 770 to at least some of users 742 in the social network.

Because information in computer system 700 may be sensitive in nature, in some embodiments at least some of the data stored in memory 724 and/or at least some of the data communicated using communication module 728 is encrypted using encryption module 738.

Instructions in the various modules in memory 724 may be implemented in a high-level procedural language, an object-oriented programming language, and/or in an assembly or machine language. Note that the programming language may be compiled or interpreted, e.g., configurable or configured, to be executed by the one or more processors.

Although computer system 700 is illustrated as having a number of discrete items, FIG. 7 is intended to be a functional description of the various features that may be present in computer system 700 rather than a structural schematic of the embodiments described herein. In practice, and as recognized by those of ordinary skill in the art, the functions of computer system 700 may be distributed over a large number of servers or computers, with various groups of the servers or computers performing particular subsets of the functions. In some embodiments, some or all of the functionality of computer system 700 is implemented in one or more application-specific integrated circuits (ASICs) and/or one or more digital signal processors (DSPs).

Computer systems (such as computer system 700), as well as electronic devices, computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1) and/or computer system 700 may include fewer components or additional components. Moreover, two or more components may be combined into a single component, and/or a position of one or more components may be changed. In some embodiments, the functionality of system 100 (FIG. 1) and/or computer system 700 may be implemented more in hardware and less in software, or less in hardware and more in software, as is known in the art.

While a social network has been used as an illustration in the preceding embodiments, more generally the customization technique may be used to dynamically customize content in a wide variety of applications or systems, including news, media, online forums and entertainment applications. Moreover, the customization technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the customization technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A method for generating customized content, wherein the method comprises:
identifying a set of format options for documents in a set of documents;
selecting an initial format and an initial ordering of the documents in the set of documents;
presenting the set of documents to a subset of users of a social network;
receiving behavior information specifying user behaviors in the social network, wherein the user behaviors include a number of views of the set of documents, a number of documents viewed in the set of documents and a duration of the views;
revising at least one of the initial format and the initial ordering based on the behavior information, wherein the behavior information includes user behaviors associated with the set of documents and user behaviors associated with a second set of documents that is related to the set of documents; and
simultaneously presenting the set of documents to a first user with the initial format and the initial ordering, and to a second user with the revised format or the revised ordering based on their user behaviors.

2. The method of claim 1, wherein the method further comprises simultaneously presenting the set of documents to a first user with the initial format and the initial ordering and the set of documents to a second user with the revised format and the revised ordering.

3. The method of claim 1, wherein the documents include one of: slides in a presentation; and frames in a video.

4. The method of claim 1, wherein the method further comprises:
determining tags associated with the documents in the set of documents, wherein a tag for a given document includes characteristics of content in the given document; and
identifying the subset of the users based on the tags and profiles of the subset of the users in the social network;
wherein each user's profile includes attributes, skills, employment history, and education of the user.

5. The method of claim 4, wherein identifying the subset of users involves:
determining match scores based on association between the characteristics and the profiles; and
selecting the subset of the users based on the match scores.

6. The method of claim 1, wherein the method further comprises identifying another set of documents based on association between the tags associated with the set of documents and tags associated with the other set of documents; and
wherein the user behavior includes a number of views of the other set of documents, a number of documents viewed in the other set of documents and a duration of the views of the other set of documents.

7. The method of claim 1, wherein the method further comprises removing one or more of the documents in the set of documents based on the behavior information.

8. The method of claim 1, wherein the method further comprises presenting the set of documents with at least one of the revised format and the revised ordering to other users in the social network.

9. The method of claim 1, wherein:
the method further comprises:
specifying a set of audio options for the documents in the set of documents; and
selecting initial audio in the set of audio options for the documents in the set of documents; and
the revising involves modifying the initial audio based on the behavior information.

10. The method of claim 9, wherein the audio options include music.

11. An apparatus, comprising:
one or more processors;
memory; and
a program module, wherein the program module is stored in the memory and, during operation of the apparatus, is executed by the one or more processors to generate customized content, the program module including:
instructions for identifying a set of format options for documents in a set of documents;
instructions for selecting an initial format and an initial ordering of the documents in the set of documents;
instructions for presenting the set of documents to a subset of users of a social network;
instructions for receiving behavior information specifying user behaviors in the social network, wherein the user behaviors include a number of views of the set of documents, a number of documents viewed in the set of documents and a duration of the views;
instructions for revising at least one of the initial format and the initial ordering based on the behavior information, wherein the behavior information includes user behaviors associated with the set of documents and user behaviors associated with a second set of documents that is related to the set of documents; and
instructions for simultaneously presenting the set of documents to a first user with the initial format and the initial ordering, and to a second user with the revised format or the revised ordering based on their user behaviors.

12. The apparatus of claim 11, wherein the program module further comprises instructions for simultaneously presenting the set of documents to a first user with the initial format and the initial ordering and the set of documents to a second user with the revised format and the revised ordering.

13. The apparatus of claim 11, wherein the documents include one of: slides in a presentation; and frames in a video.

14. The apparatus of claim 11, wherein the program module further comprises:
instructions for determining tags associated with the documents in the set of documents, wherein a tag for a given document includes characteristics of content in the given document; and
instructions for identifying the subset of the users based on the tags and profiles of the subset of the users in the social network;
wherein each user's profile includes attributes, skills, employment history, and education of the user.

15. The apparatus of claim 14, wherein the instructions for identifying the subset of users include:
instructions for determining match scores based on association between the characteristics and the profiles; and
instructions for selecting the subset of the users based on the match scores.

16. The apparatus of claim 11, wherein the program module further comprises instructions for identifying another set of documents based on association between the tags associated with the set of documents and tags associated with the other set of documents; and
wherein the user behavior includes a number of views of the other set of documents, a number of documents viewed in the other set of documents and a duration of the views of the other set of documents.

17. The apparatus of claim 11, wherein the program module further comprises instructions for removing one or more of the documents in the set of documents based on the behavior information.

18. The apparatus of claim 11, wherein the program module further comprises instructions for presenting the set of documents with at least one of the revised format and the revised ordering to other users in the social network.

19. The apparatus of claim 11, wherein:
the program module further comprises:
instructions for specifying a set of audio options for the documents in the set of documents; and
instructions for selecting initial audio in the set of audio options for the documents in the set of documents; and
the instructions for revising includes modifying the initial audio based on the behavior information.

20. A system, comprising:
a content module comprising a non-transitory computer-readable medium storing instructions that, when executed, cause the system to identify a set of format options for documents in a set of documents;
a selection module comprising a non-transitory computer-readable medium storing instructions that, when executed, cause the system to:
select an initial format and an initial ordering of the documents in the set of documents;
present the set of documents to a subset of users of a social network;
receive behavior information specifying user behaviors in the social network, wherein the user behaviors include a number of views of the set of documents, a number of documents viewed in the set of documents and a duration of the views; and
revise at least one of the initial format and the initial ordering based on the behavior information, wherein the behavior information includes user behaviors associated with the set of documents and user behaviors associated with a second set of documents that is related to the set of documents; and
a presentation module comprising a non-transitory computer-readable medium storing instructions that, when executed, cause the system to simultaneously present the set of documents to a first user with the initial format and the initial ordering and the set of documents to a second user with at least one of: the revised format, and the revised ordering based on their user behaviors.
